(19) United States
(12) Patent Application Publication
(10) Pub. No.: US 2012/0154559 A1
(43) Pub. Date: Jun. 21, 2012

(54) Generate Media

(76) Inventors: Shane D. Voss, Fort Collins, CO (US); John Mick, Fort Collins, CO (US); Jason Yost, Windsor, CO (US)

(21) Appl. No.: 12/974,142

(22) Filed: Dec. 21, 2010

(51) Int. Cl. H04N 13/00

(52) U.S. Cl. 348/55; 348/E13.026

(57) ABSTRACT

A device to calibrate with a 3D viewer, to couple to a display device, and to split a 3D signal to a first 2D signal and a second 2D signal and generate media to be rendered on the display device by merging the first 2D signal and the second 2D signal based on a timing between the device and the 3D viewer.

### BACKGROUND

When rendering 3D (three dimensional) media for display, a device can be used to initially access 3D media file and a 3D compliant display device coupled to the device can decode and/or process the 3D media file as a 3D video for display. Additionally, the device can be physically or wirelessly be coupled to 3D glasses and the device can proceed to calibrate the 3D glasses using a timing specified in the 3D media. Once the 3D glasses have been calibrated by the predefined timing, the user can use the 3D glasses to view the 3D media file.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device with a controller according to an embodiment.

FIG. 2 illustrates a block diagram of a media application splitting a 3D signal into a first 2D signal and a second 2D signal according to an embodiment.

FIG. 3A and FIG. 3B illustrate a device coupled to a display device and the device calibrating with a 3D viewer according to an embodiment.

FIG. 4 illustrates a block diagram of a media application generating media according to an embodiment.

FIG. 5 illustrates a media application on a device and a media application stored on a removable medium being accessed by the device according to an embodiment.

FIG. 6 is a flow chart illustrating a method for generating media according to an embodiment.

FIG. 7 is a flow chart illustrating a method for generating media according to another embodiment.

### DETAILED DESCRIPTION

Many display devices include compatible hardware and/or firmware to process, and/or decompress a 2D signal. However, many display devices may not include compatible hardware and/or firmware to process, decode, and/or decompress a 3D signal. As a result, many display devices may not be able to render one or more images and/or videos which can be perceived by a user viewing the display device as 3D. Additionally, when identifying a timing to display the 3D image and/or 3D video, many display devices utilize a timing specified in the 3D signal to render the 3D image and/or 3D video.

By using a controller of a device to split a 3D signal into a first 2D (two dimensional) signal and a second 2D signal, the controller can proceed to generate media by merging the first 2D signal with the second 2D signal based on a timing between the device and a 3D viewer as opposed to a predefined timing included in the 3D signal. When identifying the timing, the device can be calibrated with the 3D viewer. As a result, the media can be rendered as a 2D signal for a user perceive as 3D when viewing the media on a display device which may not include compatible hardware and/or firmware to process, decode, and/or decompress a 3D signal.

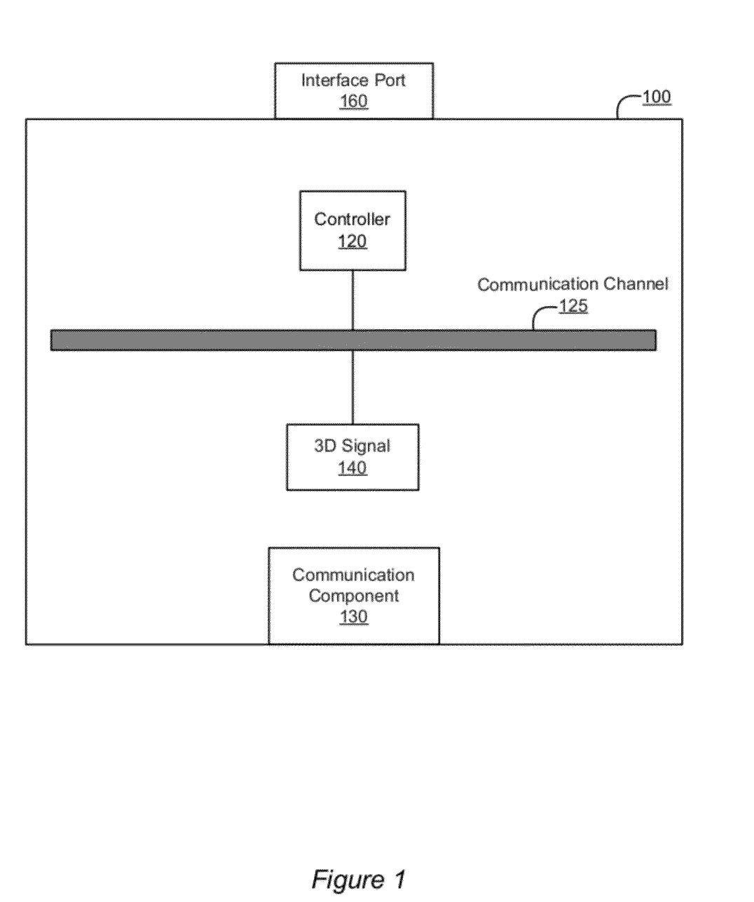

FIG. 1 illustrates a device 100 with a controller 120 according to an embodiment. In one embodiment, the device 100 is or includes a media player, an entertainment system, a desktop, a laptop, a notebook, a tablet, a netbook, an all-in-one system, a server, and/or the like. In another embodiment, the device 100 is a cellular device, a PDA, are E-Reader, and/or any additional device which can include a controller 120.

As illustrated in FIG. 1, the device 100 includes a controller 120, a an interface port 160, a communication component 130, and a communication channel 150 for the device 100 and/or one or more components of the device 100 to communicate with one another. Additionally, the device 100 can include one or more 3D signals 140 accessible to the controller 120. In one embodiment, the device 100 additionally includes a media application stored on a storage device coupled to the device 100. In other embodiments, the device 100 includes additional components and/or is coupled to additional components in addition to and/or in lieu of those noted above and illustrated in FIG. 1.

As noted above, the device 100 includes a controller 120. The controller 120 can send data and/or instructions to the components of the device 100, such as the interface component 160, the communication component 130, and/or the media application. Additionally, the controller 120 can receive data and/or instructions from components of the device 100, such as the interface component 160, the communication component 130, and/or the media application.

The media application is an application which can be utilized in conjunction with the controller 120 to generate media to be rendered for display on a display device. When generating the media, the media application and/or the controller 120 initially access a 3D signal 140 and split the 3D signal 140 into a first 2D signal and a second 2D signal. For the purposes of this application, a 3D signal 140 can include data and/or one or more files which include stereoscopic images. The stereoscopic images can include one or more first 2D images and one or more second 2D images corresponding to each first 2D image.

A first 2D signal and a second 2D signal can include one or more images from the stereoscopic images of the 3D signal 140. When splitting the 3D signal 140 into the first 2D signal and the second 2D signal, the media application and/or the controller 120 can include the corresponding first images from the stereoscopic images in the first 2D signal. Additionally, the media application and/or the controller 120 can include the corresponding second images from the stereoscopic images in the second 2D signal.

The media application and/or the controller 120 can calibrate the device 100 with one or more 3D viewers through a communication component 130 of the device 100 to identify a timing between the device 100 and the 3D viewer. The communication component 140 can be a component configured to couple and/or interface the device 100 with the 3D viewer when identifying the timing. For the purposes of this application, a timing corresponds to a timing between a frame or image of a media leaving the device 100 and a shutter of a 3D viewer being in a viewable state. A 3D viewer can be a hardware device or component which can include one or more shutters which can alternate between one or more states. In one embodiment, the 3D viewer can include 3D glasses which the user can wear.

When calibrating the device 100 with a 3D viewer, the media application and/or the controller 120 can identify one or more shutter timings of the 3D viewer and proceed to identify the timing to be used in the media based on one or more of the shutter timings, In response to identifying the timing, the media application and/or the controller 120 can proceed to merge the first 2D signal with the second 2D signal using the timing to generate media. In one embodiment, the media is generated as a 2D video stream. The media application and/or the controller can use the timing to specify how long one or more images of the media are to be displayed.

Once the media has been generated, the media application and/or the controller 120 can render the media on a display device and a user can view the media using the 3D viewer. The display device can be a non-3D display device. The device 100 can be coupled to the display device through an interface port 160. The interface port 160 is a component configured to couple and/or interface the device 100 with the display device. By generating the media based on the first 2D signal, the second 2D signal, and the timing, the user can perceive the media as 3D when viewing the media through the 3D viewer.

The media application can be firmware which is embedded onto the controller 120, the device 100, and/or the storage device of the device 100. In another embodiment, the media application is an application stored on the device 100 within ROM or on the storage device accessible by the device 100. In other embodiments, the media application is stored on a computer readable medium readable and accessible by the device 100 or the storage device from a different location.

Additionally, in one embodiment, the storage device is included in the device 100. In other embodiments, the storage device is not included in the device 100, but is accessible to the device 100 utilizing a network interface included in the device 100. The network interface can be a wired or wireless network interface card. In other embodiments, the storage device can be configured to couple to one or more ports or interfaces on the device 100 wirelessly or through a wired connection.

In a further embodiment, the media application is stored and/or accessed through a server coupled through a local area network or a wide area network. The media application communicates with devices and/or components coupled to the device 100 physically or wirelessly through a communication bus 150 included in or attached to the device 100. In one embodiment the communication bus 150 is a memory bus. In other embodiments, the communication bus 150 is a data bus.

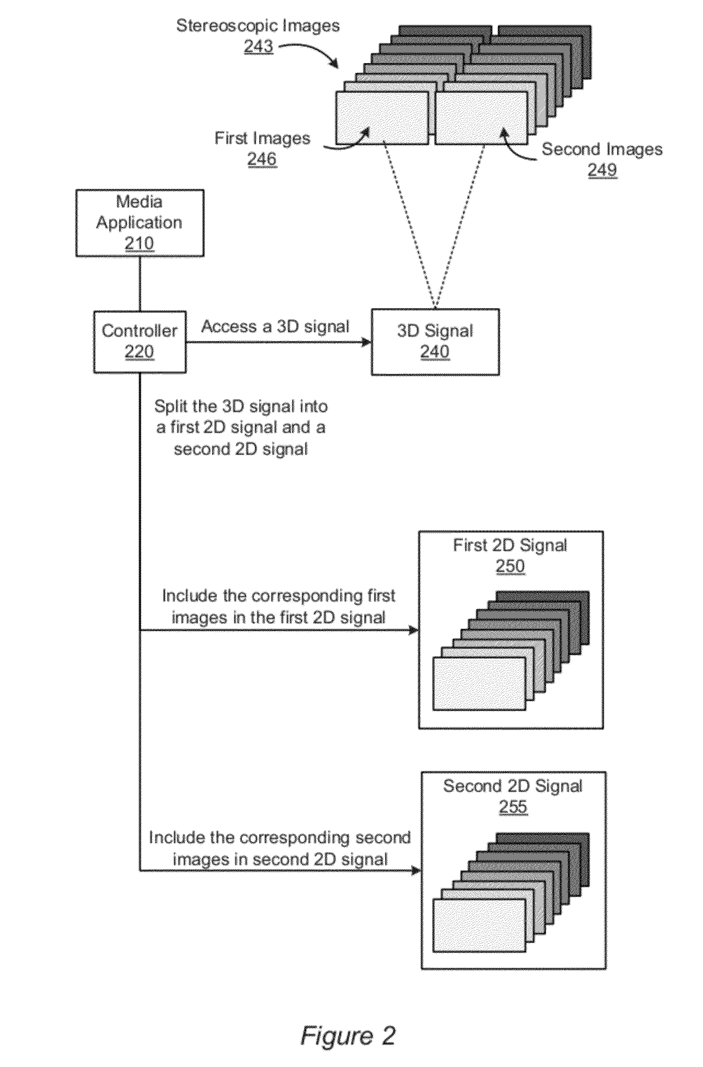

FIG. 2 illustrates a block diagram of a media application 210 accessing and splitting one or more 3D signals 240 into a first 2D signal 250 and a second 2D signal 255 according to an embodiment. As noted above, a 3D signal 240 can include one or more files, such as a video file. The video the can include one or more 3D video streams, which can include one or more stereoscopic images 243. The stereoscopic images 243 include one or more first images 246 and one or more second images 249. As illustrated in the present embodiment, each of the first images 246 correspond to a second image 249.

One or more of the 3D signals 240 can be stored and accessed by the media application 210 and/or a controller 220 from a storage device on the device. In another embodiment, one or more of the 3D signals 240 can be stored on another location on the device or on any additional device or component accessible to the media application 210 and/or the controller 220. In response to accessing a 3D signal 240, the media application 210 and/or the controller 220 can proceed to split the 3D signal 240 into a first 2D signal 250 and a second 2D signal 255.

One or more of the 2D signals can be generated by the media application 210 and/or the controller 220 to include one or more of the images from the 3D signal 240. In one embodiment, as illustrated in FIG. 2, when splitting the 3D signal 240 into a first 2D signal 250 and a second 2D signal 255, the media application 210 and/or the controller 220 can initially access the set of first images 246 from the 3D signal 240 and proceed to include the corresponding first images 246 in the first 2D signal 250.

The media application 210 and/or the controller 220 additionally access the set of second images 249 from the 3D signal 240 and includes the corresponding second images 249 in the second 2D signal 255. The media application 210 and/or the controller 220 can repeat this method until all of the stereoscopic images 243 have been distributed into the first 2D signal 250 and the second 2D signal 255.

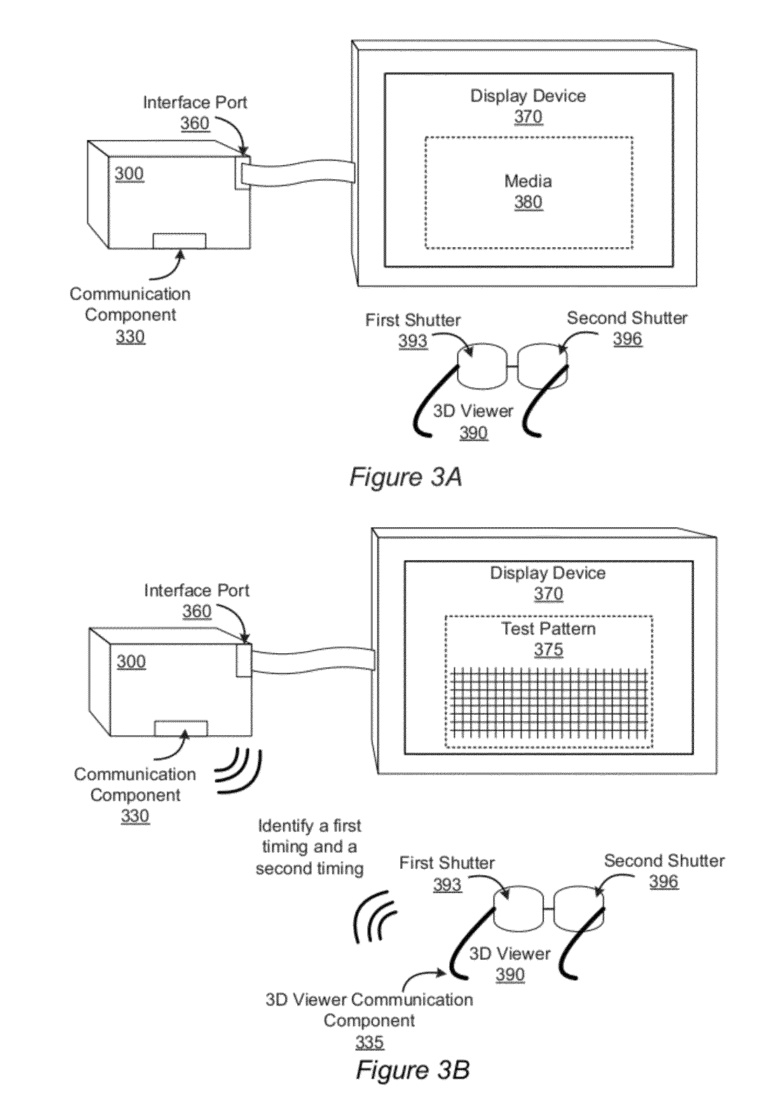

FIG. 3A and FIG. 3B illustrate a device 300 coupled to a display device 370 and the device 300 calibrating with a 3D viewer 390 according to an embodiment. As illustrated in FIG. 3A, the device 300 includes an interface component 360. The interface component 360 is a hardware component of the device 300 configured to couple the device 300 to the display device 370 and allow the device 300 to interface with the display device 370.

In one embodiment, the interface component 360 includes one or more ports. One or more of the ports can be or include a VGA (video graphics array) port, a DVI (Digital Visual Interface) port, an S-Video port, a composite video port, and/or an HDMI (High definition multimedia interface) port. In other embodiments, the interface component 360 can include additional ports or devices configured to couple the device 300 to the display device 360.

The display device 370 is an output device configured by a media application and/or a controller of the device 300 to render media 380 as one or more images and/or videos. The media 380 can include one or more images rendered as a 2D video stream for display on the display device 370. In one embodiment, the display device 370 can be a LCD (liquid crystal display), a LED (light emitting diode) display, a CRT (cathode ray tube) display, a plasma display, a projector and/or any additional device configured to render the media 380, In another embodiment, the display device 370 is not a 3D display device.

Additionally, as illustrated in FIG. 3A, the device 300 can include a communication component 330. The communication component 330 is a hardware device or component configured to couple and/or interface the device 300 with a 3D viewer 390. In one embodiment, the communication component 330 can include an infrared component, a Bluetooth component, a wireless network component, and/or a radio component. In another embodiment, the communication component 330 can include additional devices and/or components configured to allow the device 300 to interface with the 3D viewer 390.

As noted above, a 3D viewer 390 can be a device or component which can include one or more shutters which can alternate between a viewable state and a non-viewable state. One or more of the shutters can include one or more liquid crystal layers, one or more opaque layers, one or more polarized layers or filters, one or more colorcode 3D layers, and/or any additional layer or filter. As illustrated in FIG. 3A, in one embodiment, the 3D viewer 390 can be or include one or more pair of glasses. The pair of glasses can include a first shutter 393 and a second shutter 396. Using the 3D viewer, a user can view the media 380 through the 3D viewer and perceive the media 380 as a 3D image or video.

Additionally, as noted above and as illustrated in FIG. 3B, the device 300 can calibrate with the 3D viewer 390 to identify a timing between the device 300 and the 3D viewer 390. When identifying the timing, the media application and/or the controller can render one or more test patterns 375 for display on the display device 370. One or more test patterns 375 include one or more images which can be displayed on the display device 370. When rendering one or more test patterns 375, the media application and/or the controller can alternate the displaying of one or more of the images using one or more different timings.

In one embodiment, one or more of the images of the test pattern 375 can include one or more images of horizontal lines and one or more of the images can include vertical lines. The media application and/or the controller can alternate the images of the horizontal fines with the images of the vertical lines at one or more of the different timings. A user can then view the test pattern 375 on the display device 370 through one or more shutters of the 3D viewer 390.

In one embodiment, when identifying a first timing for a first shutter, the second shutter 396 can remain non-viewable while the first shutter 393 alternates between viewable state and a non-viewable state. For the purposes of this application, a first timing corresponds to a timing between a frame or image of a media leaving the device 100 and a first shutter 393 of the 3D viewer 390 being in a viewable state.

As the first shutter alternates between the viewable state and a non-viewable state, the media application and/or the controller can alternate the images of horizontal lines with images of the vertical lines at one or more different times or rates. The user can be prompted to access the device 300 and/or a 3D viewer communication component 335 to identify when the user sees horizontal lines and no vertical lines.

The 3D viewer communication component 335 is a hardware component to couple and/or interface the 3D viewer 390 with the device 300, In one embodiment, the 3D viewer communication component 335 includes an infrared component, a Bluetooth component, a wireless network component, a radio component, and/or any other component to allow the 3D viewer 390 to communicate with the device 300.

The user should view the horizontal lines and no vertical lines when the current selected timing or rate to alternate the horizontal images matches the first shutter timing 393 of the 3D viewer 390. The media application and/or the controller can determine when the device 300 and/or the 3D viewer communication component 335 have been accessed and identify the current selected timing or rate to alternate the images as the first timing.

Once the first timing has been identified, the second timing can be identified by making the first shutter non-viewable and alternating the second shutter 396 between the viewable state and non-viewable state. The user can view the test pattern 375 through the second shutter 396 of the 3D viewer and access the device 300 and/or the 3D viewer communication component 335 when the user sees vertical ones and no horizontal lines.

Similar to above, the user should view the vertical lines and no horizontal lines when the current selected timing or rate to alternate the images horizontal images matches the second shutter timing 393 of the 3D viewer 390. The media application and/or the controller can determine when the device 300 and/or the 3D viewer communication component 335 have been accessed and identify the current selected timing or rate to alternate the images as the second timing.

In another embodiment, an image capture device can be used in place of the user to calibrate the device 300 with the 3D viewer 390. The image capture device can be coupled to the 3D viewer 390 or positioned in front of the display device 370 and can be used to identify the first timing and/or the second timing to be used as the timing. The image capture device can notify the media application and/or the controller when it views horizontal lines without vertical lines through the first shutter 393 timing and when it views vertical lines without horizontal lines through the second shutter 396.

In one embodiment, the first timing X can be the same as the second timing X. As a result, the timing can include a single timing of X for the first shutter 393 and the second shutter 396. In another embodiment, the first timing X can be different from the second timing Y. As a result, the timing can include two different timings of X and Y. A first timing X for a first shutter 393 and a second timing Y for a second shutter 396.

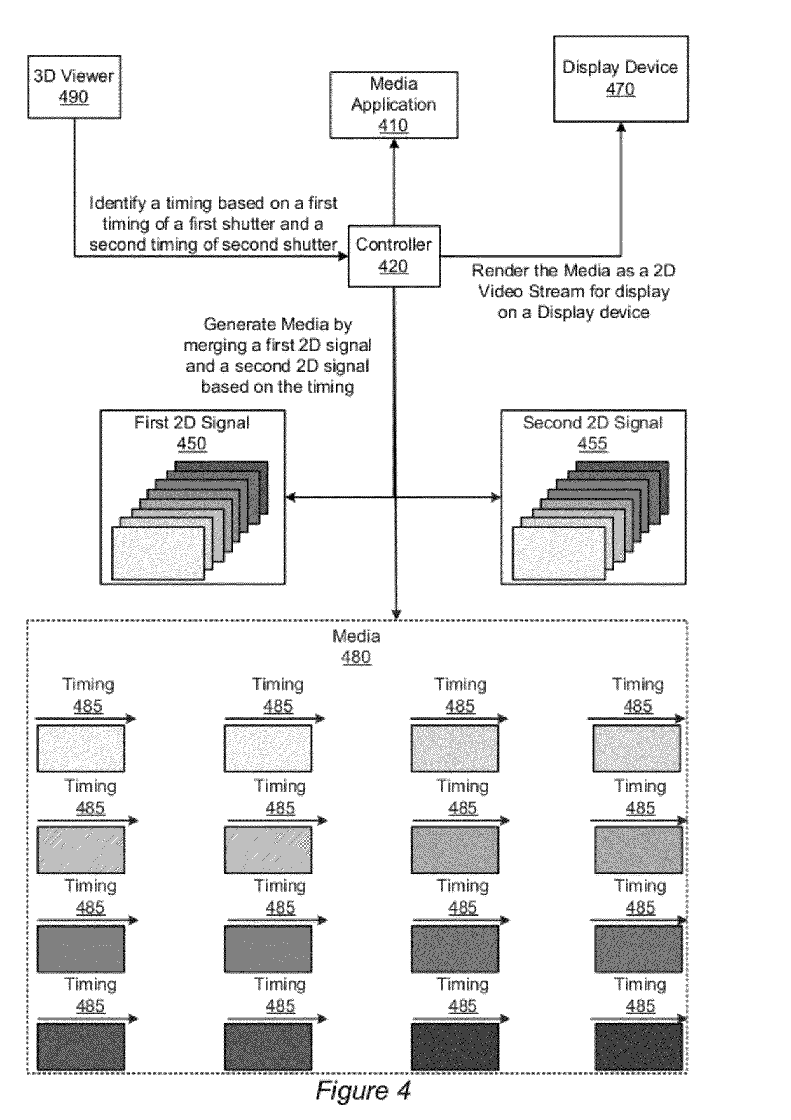

FIG. 4 illustrates a block diagram of a media application 410 generating media 480 according to an embodiment. As noted above, the media application 410 and/or the controller 420 can generate media 480 using a first 2D signal 450 and a second 2D signal 455 based on a timing 485. In one embodiment, the media 480 can be generated as a 2D video stream. As illustrated in FIG. 4, the media application 410 and/or the controller 420 have identified a timing 485 by identifying a first timing of a first shutter of the 3D viewer 490 and second timing of a second shutter of the 3D viewer 490.

In response, the media application 410 and/or the controller 420 proceed to access corresponding first images from the first 2D signal 450 and corresponding second images from the second 2D signal 455 and include them in the media 480. As illustrated in FIG. 4, when including the images in the media 480, the media application 410 and/or the controller 420 sequentially alternate the corresponding first images from the first 2D signal 450 with the corresponding second images from the second 2D signal 455 one by one.

Additionally, as illustrate in FIG. 4, the media application 410 and/or the controller 420 use the identified timing 485 when including the corresponding first images from the corresponding second images. In one embodiment, if the media application 410 and/or the controller 420 previously determined that the first timing X for the first shutter is the same as the second timing X for the second shutter, the timing includes a single timing of X. As a result, the images included the media 480 are each rendered at the timing 485 of X.

In one embodiment, the timing 485 of X includes how long to render each of the images. In another embodiment, the timing 485 of X includes how long to render each of the images and any delay and/or latency between one or more of the images. In other embodiments, if the media application 410 and/or the controller 420 previously determined that the first timing X for the first shutter is different from the second timing Y for the second shutter, the timing 485 includes two different timings of X and Y.

In response, the media application 410 and/or the controller alternate between using the timings of X and Y when determining how long to render each of the images in the media 480. As a result, a first image included in the media 480 is rendered using the first timing X and the second image is rendered at the timing Y. This method is repeated for each of the images included in the media 480. Once the media 480 has been generated, the media application 410 and/or the controller 420 can render the media 480 for display on a display device 470. A user can then view the media 480 on the display device 470 through the 3D viewer 490.

In another embodiment, the media application 410 and/or the controller 420 can determine whether the display device 470 supports a refresh rate or a Hz to display the media 480. The refresh rate can be a frames per second which the display device 470 can display. The media application 410 and/or the controller 420 can determine whether the display device 470 supports the refresh rate based on a make, model, and/or manufacturer of the display device 470. In another embodiment, the media application 410 and/or the controller 420 can poll the display device 470 for supported refresh rates.

If the display device 470 does not include a compatible refresh rate, the media application 410 and/or the controller 420 can send an instruction to the 3D viewer 490 to modify a first timing for a first shutter and/or to modify a second timing for a second shutter based on the previously identified timing 485 and/or the refresh rate of the display device 470. By modifying the first timing and/or the second timing, a shutter speed of the first shutter and/or the second shutter can be modified.

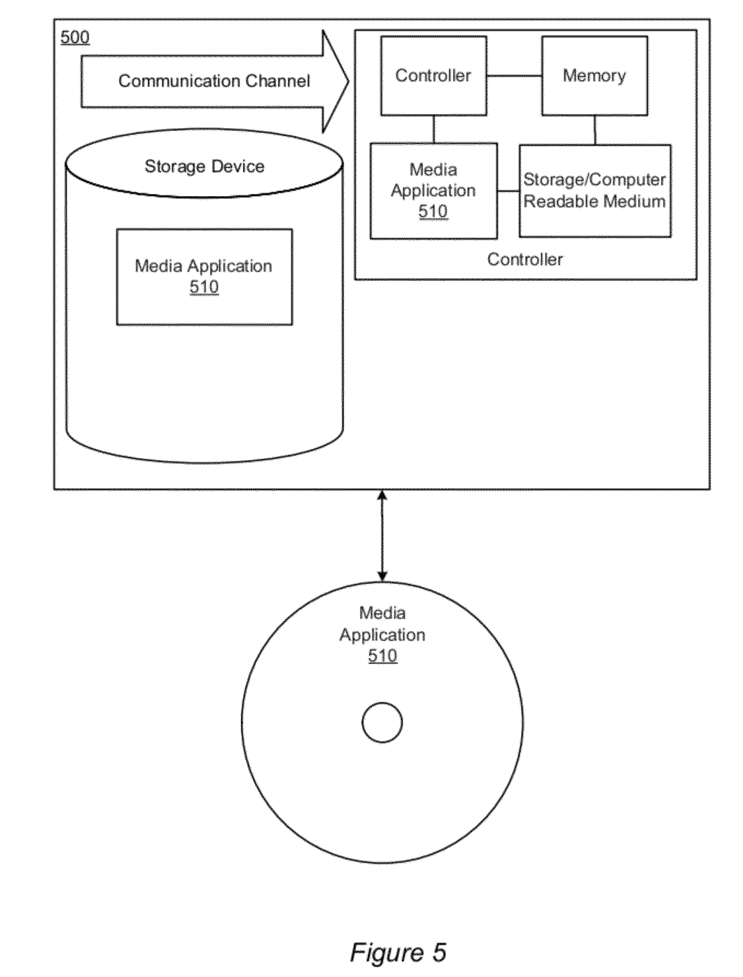

FIG. 5 illustrates a device 500 with a media application 510 and a media application 510 stored on a removable medium being accessed by the device 500 according to an embodiment of the invention. For the purposes of this description, a removable medium is any tangible apparatus that contains, stores, communicates, or transports the application for use by or in connection with the device 500. As noted above, in one embodiment, the media application 510 is firmware that is embedded into one or more components of the device 500 as ROM. In other embodiments, the media application 510 is an application which is stored and accessed from a hard drive, a compact disc, a flash disk, a network drive or any other form of computer readable medium that is coupled to the device 500.

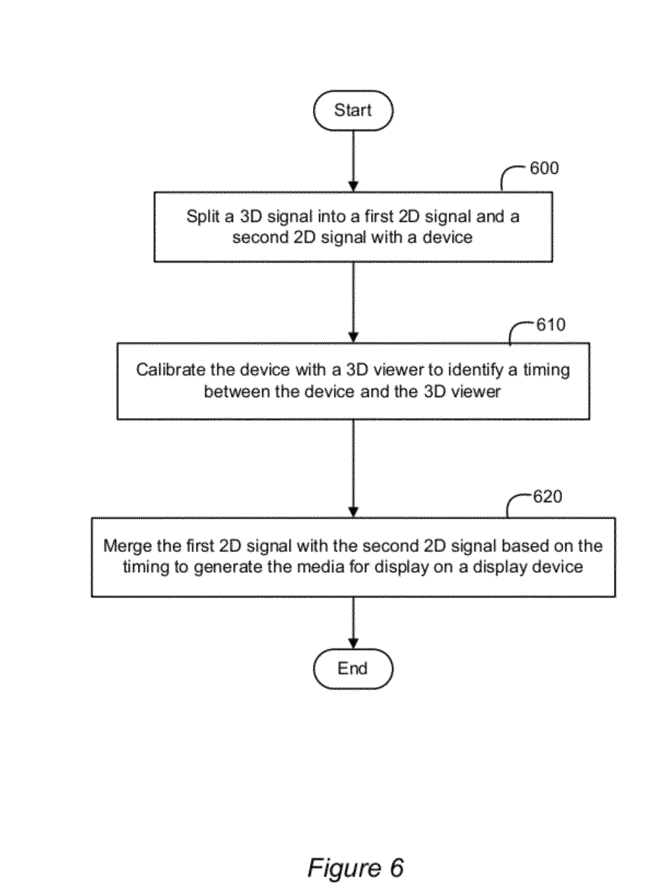

FIG. 6 is a flow chart illustrating a method for generating media according to an embodiment. The method of FIG. 6 uses a device with a controller, an interface port, a communication port, a communication channel, and/or a media application. In other embodiments, the method of FIG. 6 uses additional components and/or devices in addition to and/or in lieu of those noted above and illustrated in FIGS. 1, 2, 3, 4, and 5.

As noted above, the media application is an application which can be used in conjunction with the controller to access a 3D signal and split the 3D signal into a first 2D signal and a second 2D signal 600. The 3D signal can include data and/or one or more files. The data and/or a file can include a 3D video stream which includes stereographic images.

The stereographic images can include a first set of images and a second set of images. Each of the second images from the second set of images can correspond to a first image from the first set of images. When splitting the 3D signal_{;} the media application and/or the controller can access the first images from the first set and include the first images into a first 2D signal. Additionally, the media application and/or the controller can access the second images from the second set and include the second images into a second 2D signal.

As noted above, the device can additionally be calibrated with a 3D viewer to identify a timing between the device and the 3D viewer 610. The 3D viewer is a hardware component which includes one or more shutters. One or more of the shutters can alternate between a viewable state and a non-viewable state. When calibrating the device with the 3D viewer, the media application and/or the controller can render one or more test patterns for display on a display device coupled to the device.

The display device can be coupled to the device through the interface port of the device. The interface port is a hardware component configured to couple and interface the device with the display device. The interface port can include a VGA port, a DVI port, a HDMI port, a s-video port, and/or any additional port which the display device can couple to.

As noted above, the test pattern can include one or more images. In one embodiment, one or more of the images can include horizontal lines and one or more of the images can include vertical lines. In other embodiments, one or more of the images of the test pattern can display additional information and/or images in addition to and/or in lieu of those noted above. When displaying the test pattern, the media application and/or the controller can alternate the images of the horizontal lines with the images of the vertical lines using one or more different timings or rates. Additionally, a user can view the test pattern through the 3D viewer. In one embodiment, the 3D viewer can be a pair of glasses which includes two shutters. A first shutter for a left eye of the user and a second shutter for a right eye of the user.

When identifying the timing, the second shutter can become non-viewable while the first shutter alternates between the viewable state and the non-viewable state. The user can view the test pattern through the first shutter at the different timings and identify when the user sees horizontal lines and no vertical lines. The media application and/or the controller can identify which timing was being used to alternate the horizontal and vertical images of the test pattern and identify the corresponding timing as a first timing for the first shutter.

Once the first timing has been identified, the first shutter can remain non-viewable while the second shutter alternates between viewable and non-viewable. The user can identify when the user sees vertical lines with no horizontal lines. The media application and/or the controller can then identify the corresponding timing being used to alternate the images as the second timing for the second shutter. Once the timing has been identified, the media application and/or the controller can generate media by merging the first 2D signal with the second 2D signal based on the timing 620.

As noted above, when merging the media, the media application and/or the controller can initially take a first image from the first 2D signal and include it in the media based on the timing. The media application and/or the controller can then include an associated second image from the second 2D signal based on the timing. As noted above, if the first timing X is the same as the second timing X, the timing will be identified to include a single timing X. As a result, the images from in the media can each be displayed using the timing X.

In another embodiment, if the first timing X is different from the second timing Y, the timing will include two timings, X for the first shutter and Y for the second shutter. As a result, the first image from the first 2D signal can be displayed using the timing X and the next image from the second 2D signal can be displayed using the timing Y. The media application and/or the controller can alternate and repeat this method until all of the images in the first 2D signal and the second 2D signal have been included in the media based on the timing.

By merging the images from the first 2D signal with the images from the second 2D signal based on the identified timing, the media application and/or the controller can generate the media as a 2D video stream which can be rendered on the display device. Once the media is rendered on the display device, the user can view the media and perceive the media as 3D through the 3D viewers. The method is then complete or the media application and/or the controller can continue to calibrate the device with the 3D viewer to update the timing. In other embodiments, the method of FIG. 6 includes additional steps in addition to and/or in lieu of those depicted in FIG. 6.

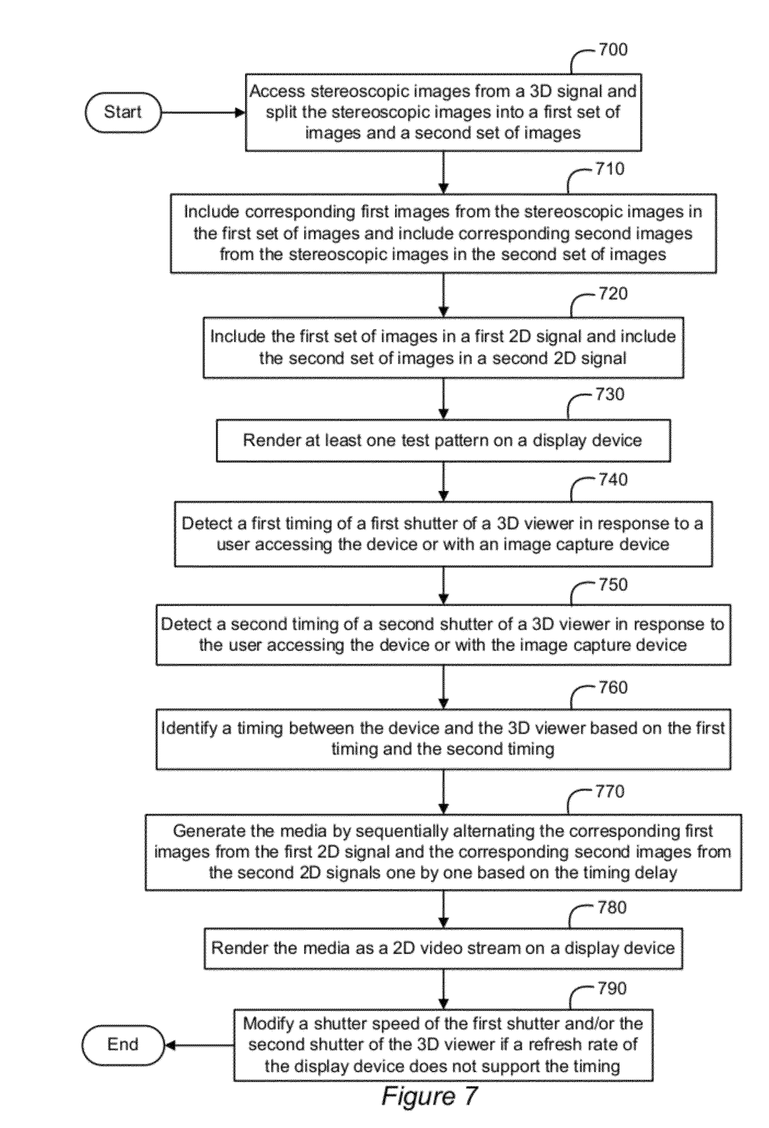

FIG. 7 is a flow chart illustrating a method for generating media according to another embodiment. Similar to above, the method of FIG. 7 uses a device with a controller, an interface port, a communication port, a communication channel, and/or a media application. In other embodiments, the method of FIG. 7 uses additional components and/or devices in addition to and/or in lieu of those noted above and illustrated in FIGS. 1, 2, 3, 4, and 5.

As noted above, the media application and/or the controller of the device can access stereoscopic images from a 3D signal and proceed to split the stereoscopic images into a first set of images and a second set of images 700. The 3D signal can be stored on a storage device of the device. In another embodiment, the 3D signal can be stored on a computing machine, a device, and/or any on any additional location accessible to the media application and/or the controller.

When splitting the stereoscopic images, the media application and/or the controller can include first images from into the first set of images and include second images, corresponding to the first images, into the second set of images 710. Once all of the stereoscopic images from the 3D signal have been spot into the first set of images and the second set of images, the first set of images can be included in a first 2D signal and the second set of images can be included in a second set of images 720.

The media application and/or the controller can then proceed to calibrate the device with a 3D viewer to identify a timing between the device and the 3D viewer. As noted above, the 3D viewer can couple and interface with the device through a communication component of the device. The communication component can be an infrared component, a Bluetooth component, a wireless network interface, a radio component, and/or any additional device configured to couple and interface the device with the 3D viewer. Additionally, the 3D viewer includes a 3D viewer communication component configured to couple with the communication component and interface the 3D viewer with the device.

The media application and/or the controller can render one or more test patterns for display on the device 730. One or more of the test patterns can include images which can be alternated when rendered for display. Additionally, one or more different timings can be used by the media application and/or the controller to identify a first shutter timing and a second shutter timing of the 3D viewer. As noted above, when the user accesses the device and/or the 3D viewer, the media application and/or the controller can then identify a first timing of a first shutter to be the current timing used to alternate the images of the test pattern 740, In another embodiment, an image capture device can be used to identify the first timing.

Once the first timing has been identified, the first shutter can become non-viewable while the second shutter alternates between a viewable and non-viewable state. The media application and/or the controller can then detect the user accessing the device and/or the 3D viewer a second time. Using the current timing used to alternate the images of the test pattern, the media application and/or the controller can identify the second shutter timing of the 3D viewer 750. If the 3D viewer includes additional shutters, the media application and/or the controller can repeat the method above for any additional shutters. Additionally, if more than one 3D viewer is coupled to the device through the communication component, the method above can be repeated for each of the 3D viewers.

The media application and/or the controller can then identify a timing between the device and the 3D viewer based on the first timing and the second timing 760. The media application and/or the controller can then use the identified timing to generate the media by sequentially alternating the corresponding images from the first 2D signal with the corresponding second images from the second 2D signal with the timing 770.

As noted above, if the first timing above was identified to be the same as the second timing, the timing includes a single timing X and each of the images in the media are rendered at the timing X. In another embodiment, if the first timing X was different from the second timing Y, then the timing has two timings, a first timing X for a first shutter and a second timing Y for a second shutter Y. As a result, the media application and/or the controller will alternate using the timing X for the images from the first 2D signal and the timing Y for the images in the second 2D signal in the generated media.

The media application and/or the controller can then render the media as a 2D video stream for display on the display device 780. In another embodiment, if the display device does not support a refresh rate which is compatible with the timing, the media application and/or the controller can send an instruction through the communication component for the 3D viewer to modify a shutter timing of a first shutter and/or a second shutter 790. The method is then complete. In other embodiments, the method of FIG. 7 includes additional steps in addition to and/or in lieu of those depicted in FIG. 7.

What is claimed is:

1. A device comprising:
a communication component for the device to calibrate with a 3D viewer;
an interface port to couple the device to a display device; and
a controller to split a 3D signal to a first 2D signal and a second 2D signal and generate media to be rendered on the display device by merging the first 2D signal and the second 2D signal based on a timing between the device and the 3D viewer.

2. The device of claim 1 wherein the 3D signal includes stereoscopic images and the stereoscopic images include a corresponding first image and a corresponding second image.

3. The device of claim 1 wherein the first 2D signal includes the corresponding first images of the stereoscopic images of the 3D signal.

4. The device of claim 1 wherein the second 2D signal includes the corresponding second images of the stereoscopic images of the 3D signal.

5. The device of claim 1 wherein the media is generated as a 2D video stream.

6. The device of claim 5 wherein the corresponding first images in the first 2D signal are sequentially alternated with the corresponding second images from the second 2D signal one by one and separated by the timing when generating the media.

7. The device of claim 1 wherein the communication component includes at least one from the group consisting of an infrared component, a Bluetooth component, a network component, and a radio component.

8. The device of claim 1 wherein the 3D viewer includes 3D glasses and the 3D glasses include a first shutter and a second shutter.

9. The device of claim 1 further comprising a camera positioned in front of the display device to calibrate the device with the 3D viewer.

10. The device of claim 1 wherein the display device is not a 3D display device.

11. A method for generating media comprising:
splitting a 3D signal into a first 2D signal and a second 2D signal with a device;
calibrating the device with a 3D viewer to identify a timing between the device and the 3D viewer; and
merging the first 2D signal with the second 2D signal based on the timing to generate the media for display on a display device.

12. The method for generating media of claim 11 wherein calibrating the device with the 3D viewer includes the device rendering at least one test pattern on the display device.

13. The method for generating media of claim 12 wherein calibrating the device with the 3D viewer includes the device identifying a first timing for a first shutter and identifying a second timing for a second shutter of the 3D viewer.

14. The method of generating media of claim 13 wherein identifying the first timing includes the device detecting a response from a user viewing the test pattern through the first shutter.

15. The method of generating media of claim 13 wherein identifying the second timing includes the device detecting a response from a user viewing the test pattern through the second shutter.

16. The method of generating media of claim 13 wherein the timing is based on the first timing and the second timing.

17. A computer readable medium comprising instructions that if executed cause a controller to:
split stereoscopic images from a 3D signal into a first 2D signal and a second 2D signal with a device;
identify a timing between the device and a 3D viewer by calibrating the device with the 3D viewer; and
merge the first 2D signal with the second 2D signal based on the timing to generate the media for display on a display device.

18. The computer readable medium comprising instructions of claim 17 wherein the controller splits the stereoscopic images from the 3D signal into a first set of images for the first 2D signal and into a second set of images for the second 2D signal.

19. The computer readable medium comprising instructions of claim 17 wherein the first set of images includes corresponding first images of the stereoscopic images and the second set of images includes corresponding second images of the stereoscopic images.

20. The computer readable medium comprising instructions of claim 19 wherein the controller modifies a shuttering speed of at least one from the group consisting of a first shutter of the 3D viewer and a second shutter of the 3D viewer based on the timing.
